(19) United States
(12) Patent Application Publication
(10) Pub. No.: US 2010/0322033 A1
(43) Pub. Date: Dec. 23, 2010

(54) MAST-MOUNTED SONAR

(75) Inventors: Herve Le Gras, Roquefort Les Pins (FR); Christian Bergogne, Antibes (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/528,425

(22) PCT Filed: Feb. 23, 2008
(86) PCT No.: PCT/EP08/51719

§ 371 Date: Oct. 16, 2009

(30) Foreign Application Priority Data
Feb. 23, 2007 (FR) 07/01317

(51) Int. Cl. G01S 15/00

(52) U.S. Cl. 367/87

(57) ABSTRACT

The present invention relates to a sonar surveillance system for coastal protection and port surveillance comprising: an anchoring structure; a support mast designed to be mounted on the structure and arranged on the latter so as to adopt a substantially vertical position; a platform mounted on the top of the mast and receiving a sonar head; a float fixed to the mast, in proximity to the top, the buoyancy of which is sufficient to keep the mast in the vertical position, when the latter is subjected to the action of movement of the water masses in which it is immersed. The length of the mast is determined so as to position the sonar head at a depth for which the latter offers maximum performance in terms of detection range.

### FIELD OF THE INVENTION

The present invention relates to the general field of sonar protection of coastal areas and port surveillance.

It more particularly relates to a means for ensuring, with greater efficiency, the deployment and setting up of sonar systems, installed in a fixed, immersed position, so as to provide such protection.

### CONTEXT OF THE INVENTION

### Prior Art

In the issues of coastal surveillance and/or port protection, the underwater environment to be watched generally corresponds to shallow water, but this depth can, however, range up to several tens of meters. Now, it is known that the propagation of sound waves is not rectilinear: their path exhibits a curvature which notably depends on the variations of the speed of sound with depth. This is because, since the sea is not a uniform medium, but rather a medium that can present different stacked layers exhibiting abrupt temperature differences, the sound waves undergo, at the interfaces between the different layers, a modification of their path, which is reflected in a curvature of the latter.

The intensity of the deflection of the paths of the sound waves also depends on the speed of sound in the propagation medium, which in turn varies with depth, so that a sound emitted by a sound source will travel a different path depending on the depth at which this source is located. This variation also differs according to climatic conditions and in particular the seasons.

The range performance characteristics of a sonar correspond to the maximum distance at which a target can be located for the sonar having sent an acoustic wave to be able to detect the signal reflected by this target.

To determine these performance characteristics, performance prediction software tools are generally used, parameterized using bathythermic data.

A knowledge of the characteristic bathythermic readings of the geographic area makes it possible to determine the temperature gradient in the water column and consequently the propagation speed gradient of sound. This gradient varies mainly according to the geographic position of the measurement and the climatic conditions, in particular the seasons. These readings thus make it possible to determine, for the measurement locations concerned, the variation profile, according to depth, of the speed of propagation of sound. They also make it possible to establish curves describing, for a given geographic area and according to depth, the paths that may be followed by the acoustic wave emitted by a source located at a point in the area. Consequently, if there is a wish to put in place a sonar surveillance system covering a given area of the seabed, knowing the bathythermic data will make it possible to determine the optimum position for the system.

Regarding permanent installations, the equipment is, in most cases, fixed to the sea bottom, on a massive support that serves as ballast. Such an implementation obviously cannot provide a maximum range in all geographic/climatic cases and for the different types of sonar (frequency, antenna, etc. . . . ). Furthermore, in the case of shallow bottoms, which are those encountered in coastal surveillance, the reverberation, in particular that originating from the bottom, is often predominant and limits the detection range of the sonar. Since the latter is strongly linked to the position of the transmitter in the water column, optimizing the position of the transmitter in the water column constitutes an effective means for improving the detection range of the sonar.

### DESCRIPTION OF THE INVENTION

One aim of the invention is to propose a solution that makes it possible to make better use of the bathythermic data, when setting up fixed sonar surveillance systems, intended to provide a surveillance function, in order to maximize the range of the system by taking into account the propagation of sound.

One advantageous solution for exploiting the bathymetric data, and therefore the more or less advantageous propagation characteristics that the immersion medium can exhibit at a given depth, consists in using a sonar placed at a certain distance from the bottom, that is to say, placed under water at a depth enabling it to offer the best range characteristics.

To this end, the subject of the invention is a deployment device, for a sonar surveillance system, mainly comprising:
a massive and heavy anchoring structure intended to be immersed permanently on the bottom
a mast designed to be mounted on the structure and arranged so as to adopt a substantially vertical position when mounted on the latter,
a platform designed to be mounted on the top of the mast and configured to receive an item of sonar equipment,
a float arranged to be fixed to the mast, in proximity to the top, the buoyancy of which is sufficient to keep the mast in the vertical position, when the latter is subjected to the action of movement of the water masses in which it is immersed,
   the length of the mast being determined so as to position the sonar at a depth at which it offers maximum coverage and range performance.

According to a preferred embodiment, the mast is a telescopic mast, the length of which can be adjusted and includes remotely-controllable adjustment means.

According to another preferred embodiment, which can be combined with the preceding embodiment, the mast includes means for being removably moored to the anchoring structure.

According to this preferred embodiment, the float has sufficient buoyancy to float the assembly consisting of the mast, the platform and the sonar when the mast is separated from the anchoring structure.

According to this preferred embodiment, the system includes means making it possible to tow the system separated from the anchoring structure to a selected site including another anchoring structure.

According to a particular embodiment, the float is designed to offer variable buoyancy.

The deployment device according to the invention offers the advantage of making it possible to use a sonar system offering no particular roll and pitch compensation, but also that of a sonar system that does offer these functions. A sonar intended to be laid on the bottom can therefore be used without modifications.

It also offers the advantage of making it a simple matter to move the sonar from one site to another.

It also advantageously simplifies maintenance of the assembly.

Another subject of the invention is a monitoring system comprising a local sonar transmitter/receiver and a remote processing and management system, comprising:
a deployment device according to the invention,
a sonar transmitter/receiver installed on the platform of the installation device,
link means making it possible to link the sonar transmitter/receiver to the rest of the surveillance system and supply the necessary electrical energy to the assembly and the commands intended for the mast of the device.

Such a system offers the advantage of ensuring long-term surveillance (port or coastal protection) which remains effective over time, even though the bathymetric variations according to the seasons have a significant impact on the detection performance of the sonars.

Furthermore, by making it possible to position the sonar heads so as to maximize their range, that is, under water and off the coast, the invention is also of interest in terms of overall area coverage. This is because, in order to cover a given area, the implementation of the invention makes it possible to minimize the number of sonar heads by using a coverage that is omnidirectional azimuth-wise (see the example illustrated by FIGS. 4 and 5).

### DESCRIPTION OF THE FIGURES

The characteristics and advantages of the invention will be better appreciated from the following description, which explains the invention through a particular embodiment taken as a non-limiting example and which is based on the appended figures, which represent:

FIG. 1, the theoretical diagram of the structure of the device according to the invention,

FIG. 2, the theoretical diagram of the structure of a preferred embodiment of the device according to the invention,

FIG. 3, the illustration of phase in the deployment of a surveillance system comprising the device according to the invention in its preferred embodiment,

FIGS. 4 and 5, illustrations relating to an advantageous application of the invention.

### DETAILED DESCRIPTION

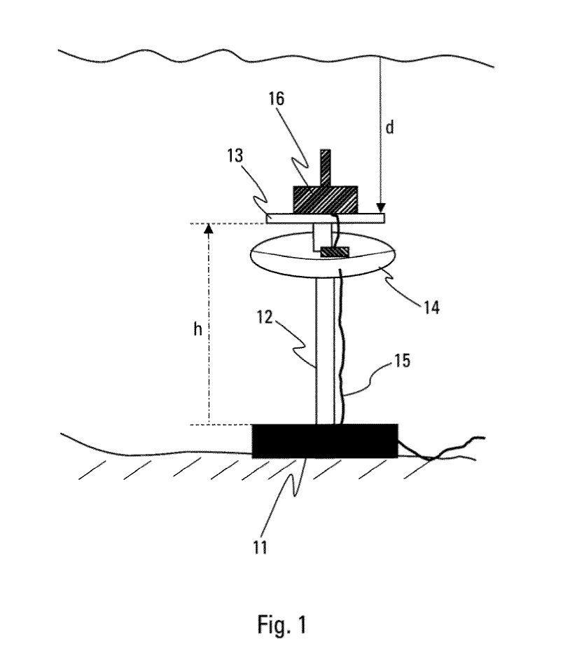

In its generic form, the device according to the invention comprises, as illustrated in FIG. 1, the following elements:
an anchoring structure 11,
a support mast 12,
a platform 13,
a float 14, and
link means 15.

The main characteristic of the anchoring structure 11 is that it is a massive item capable of being kept on the bottom despite any water mass movements. It is also capable of keeping all the elements of the device immersed. To this end, this structure can have a form and a construction that vary according to each case. It can thus, as illustrated in FIG. 1, take the form of a block of concrete or any other dense material, laid or anchored on the bottom. It can also, for certain particular applications, take the form of a metal structure planted on the bottom. In the case of a permanent surveillance system, the support structure is generally installed non-removably.

The function of the support mast 12 is to allow the platform 13 to be positioned at a given depth d. Its length, h, is therefore determined accordingly. It is fixed to the anchoring structure substantially vertically. With its rigid structure, it is designed and produced, in a known manner, to exhibit an appropriate resistance to the bending stresses that might be imposed on it, by the movement of the water masses in which it is immersed. Its hydrodynamics and its masses are determined in order to keep a vertical position with a pitch and roll amplitude that is acceptable for the sonar equipment in terms of mechanical stresses, and in terms of degradation of the detection distance performance of the sonar, degradation due to the pitch and roll of the antenna situated at the top of the mast. It can, for example, comprise a cylindrical pylon made of composite or metal material. Furthermore, the mast can be designed so as to limit its own vibrations due to the currents, by being, for example, fitted with a fairing.

The function of the platform 13 is to host the sonar head 16 which mainly comprises the antenna, and, depending on the sonar equipment concerned, all or part of the electronics of the system's sonar transmitter/receiver. The sonar head is fixed to the platform, preferably removably, by appropriate means which are not described here. The platform 13 is mounted fixedly to the top of the mast 12.

According to the invention, the length h of the support mast 12 is determined from bathythermic data so that the sonar head 16 placed on the platform 13 is immersed at a depth d such that the sonar head offers maximum performance in terms of detection range.

The role of the float 14 is to limit as far as possible the movements of the platform, movements that mainly follow the movements of the water masses, such as the swell movements or even currents. To this end, the size (the volume and the weight) and the material constituting the float are determined in a known manner according to the worst climatic conditions that can be encountered on the site. Its buoyancy is notably determined so that the force that tends to make it rise to the surface advantageously opposes any bending movement of the mast while not exerting an excessive force on the fixing means that ensure the fixing of the mast 12 to the anchoring structure.

Typically, the buoyancy of the float 14 is calculated so that the angle α assumed by the mast, under the action of the external stresses imposed by the movement of the water masses, cannot exceed a few degrees, from the vertical, this limit being variable depending on the type of sonar used (antenna size, frequency, etc.). This means that compensation for the movements of the platform is not essential to process the sonar data.

The mast 12 is fixed to the anchoring structure so as to limit the variations of orientation of the sonar head, so that no correction is imperatively required. Nevertheless, it should be noted that, since the mast is free in its pitch and roll movements, the use of position sensors can enhance the overall performance of the system. This makes it possible to assess in real time the impact of the variations of the positioning of the sonar head on its detection performance and correct this impact if necessary.

The transmission of the sonar information from the sonar head placed on the platform 13 to the remote processing and management members, situated onshore for example, and that of the operating commands sent from these same management members to the sonar head, is handled by the link means 15. These means, of various kinds, can, for example, consist of an electrical link cable or even an optical cable. Depending on the applications, these link means can also be used to provide an electrical power supply to the sonar head 16 and to all of the device. A cable then provides the bidirectional data links and the electrical power supply from the shore.

The device described in this way can advantageously be used to position the sonar head at a selected depth, while ensuring a sufficiently stable position for it such that no particular compensation of the sonar information is necessary because of the movements of the water masses.

In the above description, the device according to the invention is provided with a platform on which the sonar head can be installed. However, in a particular embodiment, the sonar head can be installed at the top of the mast, directly above the float 14 or even, if the latter is designed to include an internal housing, inside this float.

The device according to the invention, as described previously, constitutes an advantageous deployment solution compared to that consisting in laying the sonar head directly on the bottom. This solution advantageously makes it possible to position the sonar head at a depth that to a certain extent allows for the range of the sonar to be optimized, the compensation for the movements of the mast by the float 14 also making it possible to use an identical sonar head, with no particular movement compensation system.

This solution can, however, be refined to obtain the preferred embodiment described hereinafter in the document.

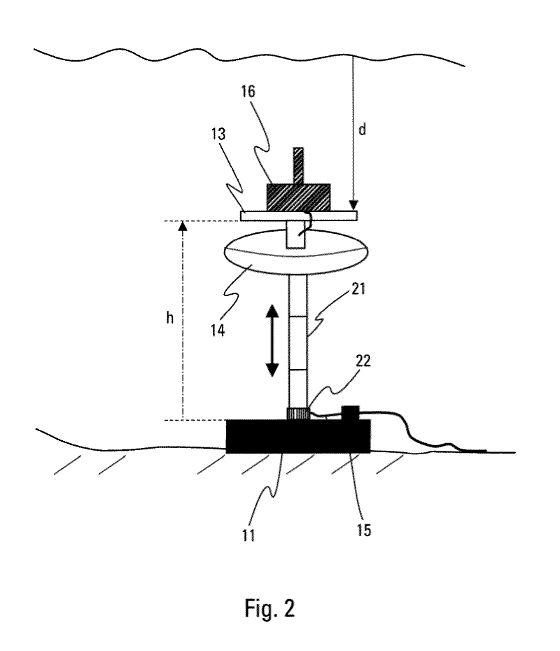

This preferred embodiment differs from the generic structure illustrated in FIG. 1 in that the device exhibits, as illustrated in FIG. 2, the following characteristics:
a) The support mast is a telescopic mast 21 that includes means for varying its length.
b) It is fixed to the anchoring structure 11 removably.

In this preferred embodiment, the support mast consists of a telescopic tubular structure 21. This structure is set in motion by means making it possible to control its elongation or contraction. These means, not represented in the figure, can, in a known manner, be mechanical, hydraulic or even electrical. They can also be actuated by remote control from the shore. To this end, the link cable 15 is designed to transmit the corresponding elongation or retraction commands. Its configuration is also adapted to take into account these variations.

We thus have a mast 21 of variable length h that makes it possible to position the sonar head 16, fixed to its top, at a depth d that can vary to order, for example according to climatic or meteorological conditions. Thus, for example, since the bathythermic conditions are variable over time, in particular according to the seasons, it is advantageously possible with this preferred embodiment of the device according to the invention to position the sonar head at a depth that makes it possible to obtain the maximum range at the moment concerned.

Also, and independently of any bathythermic condition, providing a telescopic mast 21 also makes it possible to position the sonar head 16 arbitrarily at a given depth. This capability can, for example, advantageously prove useful when the positioning of the sonar head below or above a given depth for to example proves impossible (or, on the other hand, necessary) because of the presence of temporary natural obstacles (shoals of fish, algae, etc.).

In this preferred embodiment, the telescopic support mast 21 has the characteristic of being fixed to the anchoring structure removably, by fixing means 22, an assembly comprising universal joint and shackles for example, enabling the mast to change from a locked state in which it is fixed to the anchoring structure 11, to an unlocked state in which it is entirely separated from the anchoring structure 11.

In a variant embodiment, these locking means 22 are advantageously remotely operable so that the separation of the support mast 21 from the anchoring structure 11 can be performed without the intervention of divers on the bottom. This configuration is particularly advantageous when the anchoring structure 11 is situated at a depth that is unfavorable to human interventions (typically under 30 m), which is fairly often the case.

In addition to the fact that it makes it possible to position the sonar head at the desired depth, this preferred embodiment offers great benefits in terms of maintenance and operation.

Regarding maintenance, and in particular maintenance of the sonar head, the operations relating to this task can advantageously be simplified by ordering a maximum elongation of the telescopic mast 21. In this way, the depth d at which the platform 13 supporting the sonar head 16 is located is reduced, which, for example, facilitates the intervention of divers responsible for dismantling and possibly replacing the sonar head. In certain particular cases, with a mast 21 that can be elongated to an appropriate length, it is even possible to envisage having the platform 13 emerge from the water and so make a surface intervention possible.

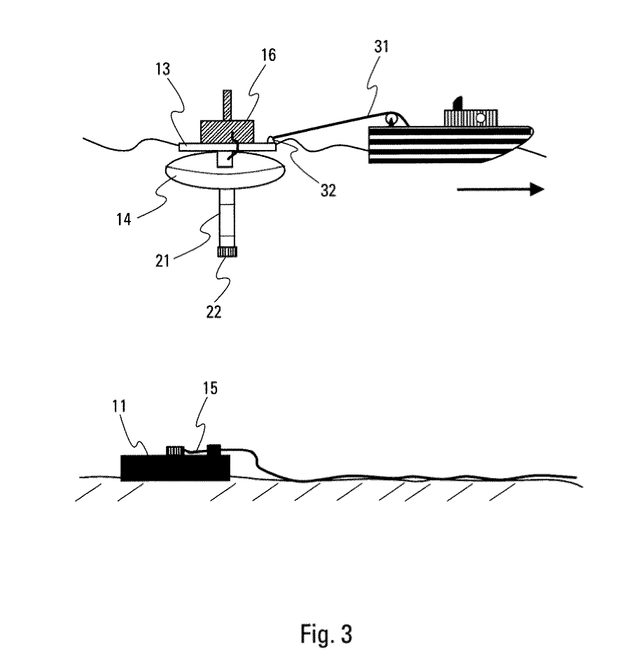

Regarding operation, this preferred embodiment of the device according to the invention makes it possible to simplify the deployment of the sonar surveillance system of which the device forms part. This is due to the fact that the support mast 12 and the elements attached thereto (platform, float and sonar head) can be separated from the anchoring structure 11, making it possible to consider a variable deployment around the area to be watched. To do this, it is sufficient, for example, to position anchoring structures 11 at selected different places, then position the sonar head fixed to its support mast vertical to the anchoring structure selected at a given instant, then finally immerse the mast and lock it to the anchoring structure concerned. Then, to obtain a different positioning, all that is required, as illustrated by FIG. 3, is to separate the mast 21 from the anchoring structure 11 concerned and allow the mast to rise to the surface under the action of the float 14, then transport this mast to the vertical from the point where the anchoring structure corresponding to the new positioning of the surveillance system is situated. Thanks to the float 14 which ensures the buoyancy of the assembly, the mast 21 and the elements that are attached thereto can be routed from one point to another using a towline 31 moored to an appropriate mooring means 32 incorporated in the device. This mooring means is, for example, fixed to the platform 13.

To facilitate the mast immersion and emergence operations, the float of the device according to the invention can, moreover, advantageously consist of a structure with variable buoyancy, comprising ballasts for example. In this way, the buoyancy of the float 14 can be lowered to facilitate the immersion of the mast in order for it to be moored, after which it can be returned to its nominal value, a value that is sufficient to ensure the rectilinearity and verticality of the mast 21 in the operational phase and the buoyancy of the whole when it is being transferred from one point to another.

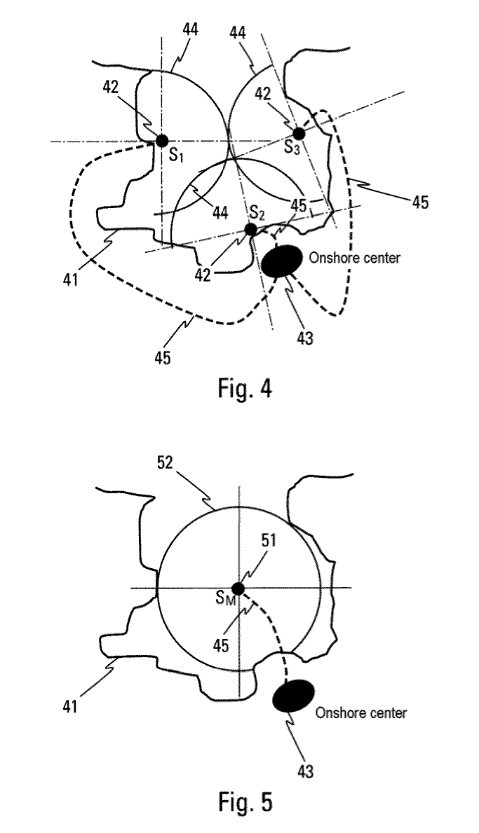

Regardless of the embodiment implemented, the device according to the invention offers particularly advantageous capabilities in terms of deployment of surveillance systems. FIGS. 4 and 5 illustrate the advantage offered by the use of a device according to the invention to implement, for example, a coastal surveillance sonar system.

FIG. 4 illustrates how a conventional sonar detection system generally has to be deployed in a bay or a harbor. Conventionally, the detection system comprises a number of sonars immersed on the sea bottom. Each sonar 42 covers an area of the underwater space represented by an arc of circle 44 that is more or less complete according to the submarine relief surrounding it. Given that the depth generally increases from the coast to the center of the bay, it is in this case necessary, with the sonars being placed on the bottom, to have several sonars in proximity to the coast 41, and the number of the sonars must be sufficient for all of the sonars to be able to cover all of the bay. An infrastructure that is relatively costly and complex to control is therefore obtained. The control center 43, generally placed on land, thus communicates with the various items of equipment 42 by means of a network of links 45 that becomes all the more extensive as the number of sonar equipment items needed increases.

FIG. 5 shows how, with the device according to the invention, it is advantageously possible to reduce the number of sonar equipment items necessary to perform the same surveillance task. As illustrated in FIG. 5, with a sonar equipment item 51 according to the invention, the sonar head can be immersed between the surface and the bottom, at a depth that makes it possible not to be hampered by the relief and to make best use of the bathythermic conditions and obtain a maximum range embodied by the circle 52 in the figure. In the optimum configuration illustrated by FIG. 5, it is thus possible to cover the area to be watched with a single sonar equipment item 51, no longer placed on the bottom along the coast 41, but placed in the position of the bay and at the depth that are most conducive to obtaining maximum range. Advantageously compared to a solution using conventional equipment, known from the prior art, the number of equipment items deployed (and therefore the maintenance operations) and the quantity of links 45 needed to link the deployed elements to the onshore center 43, are thus reduced at the same time. Ultimately, a simpler, more reliable and more cost-effective structure is obtained.

In the preceding paragraphs, the deployment device according to the invention is described in the context of the implementation with a sonar head. It is obvious that such a context of implementation is neither exhaustive nor limiting. The device according to the invention can be implemented in any other similar field in which it is necessary or at least advantageous to keep equipment immersed at a given depth.

1. A deployment device, for a sonar surveillance system, comprising:
an anchoring structure capable of being immersed substantially permanently on a bottom of a body of water;
a support mast having a top end and a bottom end, the support mast being substantially vertically mounted on the anchoring structure by the bottom end;
a platform mounted on the top end of the support mast, the platform configured to receive a sonar head;
a buoyant float proximally attached to the top of the support mast, the buoyant float having a buoyancy sufficient to keep the support mast in a substantially vertical position when the support mast is subjected to movement of water,
wherein the support mast positions the sonar head at a predetermined depth.

2. The device as claimed in claim 1, in which the support mast further comprises a fairing to limit vibrations of the support mast.

3. The device as claimed in claim 1, wherein the support mast further comprises a telescopic mast having an adjustable length and an apparatus to remotely adjust the length of the telescopic mast.

4. The device as claimed in claim 1, wherein the support mast further comprises a removable mooring for operation with the anchoring structure.

5. The device as claimed in claim 4, wherein the buoyant float has a buoyancy sufficient to float the support mast, the platform and the sonar head when the support mast is separated from the anchoring structure.

6. The device as claimed in claim 5, further comprising a towing moor to tow the support mast, the platform and the sonar head.

7. The device as claimed in claim 4, in which the buoyancy of the buoyant float is variable.

8. A sonar surveillance system, comprising:
an anchoring structure capable of being immersed substantially permanently on a bottom of a body of water;
a support mast having a top end and a bottom end, the support mast substantially vertically mounted on the anchoring structure by the bottom end;
a platform mounted on the top end of the support mast, the platform configured to receive a sonar head;
a buoyant float proximally attached to the top of the support mast, the buoyant float having a buoyancy sufficient to keep the support mast in a substantially vertical position when the support mast is subjected to the movement of water,
wherein the support mast positions the sonar head at a predetermined depth;
the sonar surveillance system further comprising:
a sonar head mounted on a deployment device, the deployment device comprising:
an electrical link to link the sonar head to the rest of the surveillance system, to supply electrical energy to one or more of the support mast, the platform and the sonar head, and to send commands to the support mast, and
a remote processing and management system.
